(19) United States
(12) Patent Application Publication
(10) Pub. No.: US 2007/0115919 A1
(43) Pub. Date: May 24, 2007

(54) Method and system for using a packet-network telephone to schedule a conference call

(75) Inventors: Taminder S. Chahal, Hoffman Estates (IN); Prasoon Saurabh, Naperville, IL (US); Jaideep Abichandani, Carol Stream, IL (US); Vikas Vashisht, Naperville, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: 3COM Corporation, Marlborough, MA (US)

(21) Appl. No.: 11/251,448

(22) Filed: Oct. 14, 2005

(51) Int. Cl. H04L 12/66

(52) U.S. Cl. 370/352

(57) ABSTRACT

A method and system for scheduling a conference call using a packet-network telephone in which a user interface of the packet-network telephone (i) is provided with a user directory that comprises a list of potential conference call participants that are selectable via the user interface, (ii) receives from the user interface, a selection of one or more persons selected from the user directory list to participate in the conference call, and (iii) transmit a signaling protocol message from the packet-network telephone to a packet-network, where the signaling protocol message is destined for a serving device for scheduling the conference call. The signaling protocol message comprises a request to schedule the conference call and a respective identifier for each of the one or more persons selected from the user directory to participate in the conference call.

### BACKGROUND

1. Field of Invention

The present invention relates to communication devices and, more particularly, to packet-network telephones.

2. Description of Related Art

A conference call is a conference by telephone in which two or more persons (i.e., conference call participants) communicate with each other by using at least two telephones that are coupled to a serving device. The serving device may include a media mixer that couples a respective communication link between the media mixer and each telephone used by any of the conference call participants. The media mixer provides switching of audio signals and other types of media to and from the conference call participants.

In one respect, during a conference call, a first telephone coupled to the serving device via a first communication link can be used by a single conference call participant. The single conference call participant may use a speaker and microphone located in a telephone handset to communicate during the conference call. In another respect, during the conference call, a second telephone coupled to the serving device via a second communication link can be used by two or more conference call participants. The two or more conference call participants may use a speaker and microphone of the second telephone that are located remote from a speaker and microphone located in a handset of the second telephone.

A conference call can be carried out over a single communication network or a combination of two or more communication networks. The communication links that couple the serving device to conference call participants' telephones may be part of one or more communication networks. Communication networks may comprise (i) a circuit-switched network (private and/or public), and/or (ii) a packet-switched network (i.e., a packet-network) (private and/or public). Other examples of communication networks are also possible.

A conference call may be an unscheduled conference call. For example, when two people engaging in a telephone call desire to speak to a third person at a location remote from the two people, a first of the two people engaging in the telephone call may (i) press a transfer button on the first person's telephone so that the first person can place another call, (ii) place the other call to the third person, and (iii) press a conference button on the first person's telephone after the third person answers the other call so as to establish a conference call between all three people. A disadvantage of an unscheduled conference call is that the third person may be called unexpectedly and may not be prepared for the conference call.

Alternatively, a conference call may be a scheduled conference call. An advantage of a scheduled conference call is that each conference call participant can be provided with notice of the conference call prior to the conference call so that each conference call participant can prepare for the conference call, as necessary.

Scheduling a conference call via a telephone has traditionally involved a conference call scheduler (i.e., the person who schedules the conference call) placing a telephone call to a conference call service provider and orally providing (i) a request to set up a conference call for a given time on a given date, and (ii) a number of expected participants and/or the names and telephone numbers of the expected participants.

Under this scheme of orally scheduling a conference call via a telephone, if, during a call to the conference call service provider, the conference call scheduler can not recall particular information (e.g., a telephone number or a name) for a potential conference call participant, the conference call scheduler may need to refer to a paper copy of a telephone directory or an electronic telephone directory to determine the particular information for the potential conference call participant. If the conference call scheduler's telephone is not located near a paper copy of a telephone directory or near a device having an electronic telephone directory, the conference call scheduler may need to (i) end the telephone call to the conference call service provider, (ii) go to a telephone directory to determine the particular information, and then (iii) place another call to the conference call service provider to orally schedule the conference call.

Since, under some circumstances, orally scheduling a conference call via a telephone can become quite burdensome, the inventors have determined that an improved mechanism for scheduling a conference call via a telephone is desirable.

### SUMMARY

The present invention advances over the existing art by providing an improved mechanism for scheduling a conference call, and in particular, for using a packet-network telephone to schedule the conference call.

One example of an embodiment of the present invention in the form of a method for using a packet-network telephone to schedule a conference call is a method that comprises (i) providing to a user interface of a packet-network telephone, a user directory accessible via the user interface, wherein the user directory comprises a list of potential conference call participants that are selectable via the user interface, (ii) receiving from the user interface, a selection of one or more persons from the user directory, wherein the one or more persons are selected to participate in the conference call, and (iii) transmitting a signaling protocol message from the packet-network telephone to a packet-network. According to this example, the signaling protocol message is destined for a serving device and comprises (i) a request to schedule the conference call, and (ii) a respective identifier for each of the one or more persons selected to participate in the conference call.

Another example of an embodiment of the present invention in the form of a method for using a packet-network telephone to schedule a conference call is a method that comprises (i) providing to a user interface of a Signaling Interface Protocol (SIP)-based packet-network telephone, a user directory accessible via the user interface, wherein the user directory comprises a list of potential conference call participants that are selectable via the user interface, and wherein the user directory is provided to the SIP-based packet-network telephone via at least a first SIP message, (ii) receiving from the user interface of the SIP-based packet-network telephone, a selection of one or more persons from the user directory, wherein the one or more persons are selected to participate in a conference call, and (iii) transmitting a second SIP message from the SIP-based packet-network telephone to a packet-network. According to this example, the second SIP message is destined for a SIP-based serving device and comprises (i) a request to schedule the conference call, and (ii) a respective identifier for each of the one or more persons selected to participate in the conference call.

Yet another example of an embodiment of the present invention comprises a packet-network telephone for scheduling a conference call. According to this example, the packet-network telephone comprises (i) a user interface, (ii) a processor, and (iii) data storage that comprises instructions executable by the processor for causing the packet-network telephone to: (a) provide to the user interface, a user directory accessible via the user interface, wherein the user directory comprises a list of potential conference call participants that are selectable via the user interface, (b) receive from the user interface, a selection of one or more persons from the user directory, wherein the one or more persons are selected to participate in a conference call, and (c) transmit a signaling protocol message to the packet-network. According to this example, the signaling protocol message is destined for a serving device and comprises (i) a request to schedule the conference call, and (ii) a respective identifier for each of the one or more persons selected to participate in the conference call.

These as well as other aspects and advantages will become apparent to those of ordinary skill in the art by reading the following detailed description, with reference where appropriate to the accompanying drawings. Further, it should be understood that the embodiments described in this summary and elsewhere are intended to be examples only and do not necessarily limit the scope of the invention.

### BRIEF DESCRIPTION OF DRAWINGS

An exemplary embodiment of the invention is described herein with reference to the drawings, in which:

FIG. 1 is a diagram illustrating an example of a packet-network telephone in which an example embodiment of the present invention can be implemented;

FIG. 2 is a simplified block diagram illustrating a packet-network telephone in which the example embodiment of the present invention can be implemented;

FIG. 3 is a simplified block diagram illustrating a network architecture for carrying out the scheduling of a conference call via a packet-network telephone in accordance with the example embodiment of the present invention;

FIG. 4 is a flow chart depicting functions that can be carried out in accordance with the example embodiment of the present invention; and

FIG. 5 is a diagram of a SIP message in accordance with the example embodiment of the present invention.

### DETAILED DESCRIPTION

1. Example Architecture

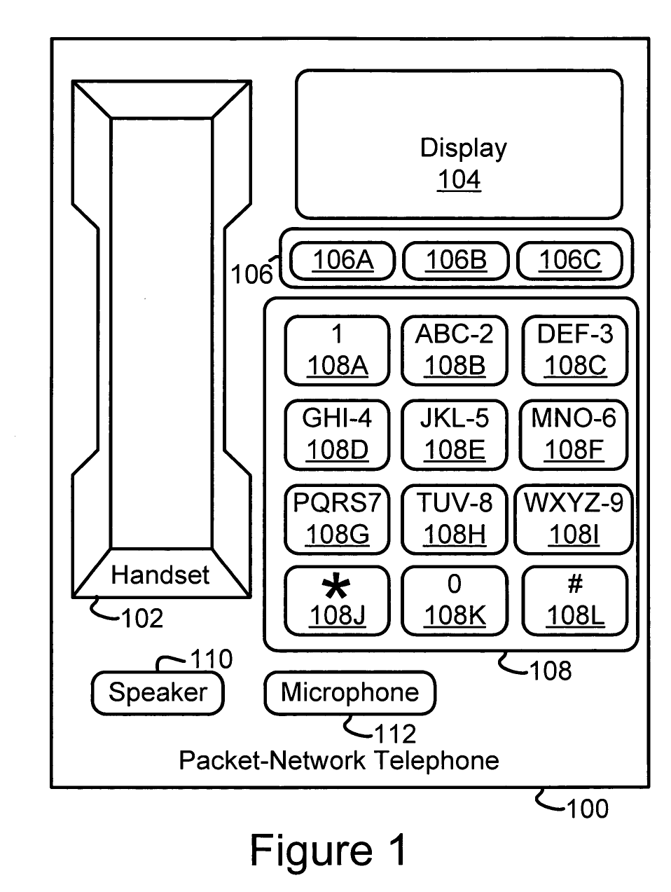

FIG. 1 depicts an example of a packet-network telephone 100 for use in carrying out the present invention. Packet-network telephones, such as the packet-network telephone 100, interface to a packet-switched network. Packet-switched networks (unlike circuit-switched networks that comprise a continuous and dedicated link between a sender and a receiver during a communication session) do not contain a continuous or dedicated link between a sender and a receiver. Rather, in a packet-switched network, data is sent from a sender to a receiver in units of data called packets that are routed through the packet-switched network to the receiver, but not necessarily along the same route for all of the packets being sent to the receiver. An example of a packet-switched network is the Internet. Another example of a packet-switched network is a private Local Area Network (LAN), such as a private LAN used by a company or a school.

A packet-network telephone, such as the packet-network telephone 100, has the look, feel, and shape of a traditional telephone, unlike a soft-phone that can be employed on a personal computer and that employs peripheral devices that couple to the personal computer. Examples of a packet-network telephone include a 3COM® 3102 Business Phone, product number 3C1042A, and a 3COM® 3103 Manager Phone, product number 3C1043A, both being manufactured by 3COM® Corporation, Marlborough, MASS, 01752-3064.

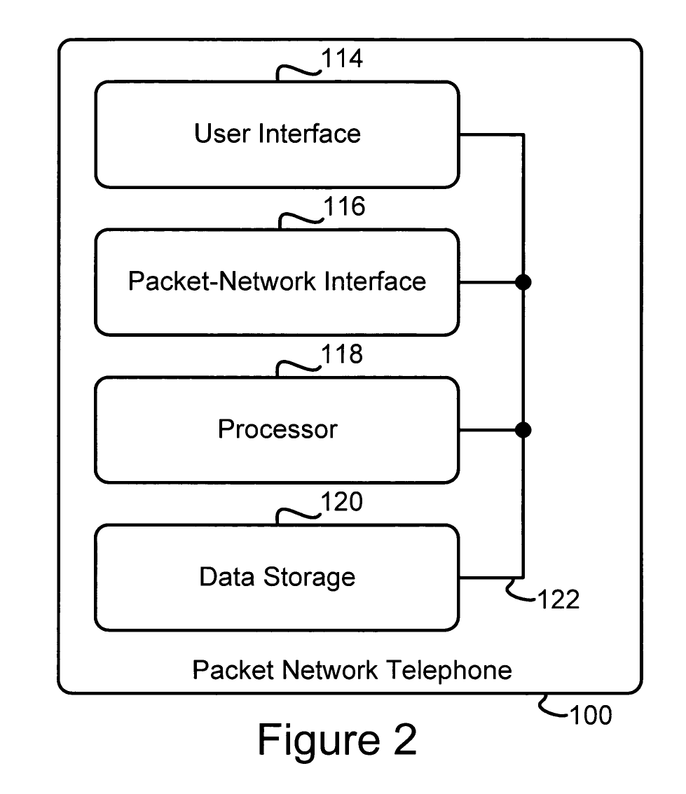

The packet-network telephone 100 comprises a handset 102, a display 104, function selection buttons 106, dialing buttons 108, a speaker 110, and a microphone 112. The packet-network telephone 100 may include other elements not shown in FIG. 1, such as the elements described below with respect to FIG. 2. One or more of the elements shown in FIG. 1 may be omitted from the packet-network telephone 100, although the functionality typically performed by such omitted elements may be performed by other elements integrated into the packet-network telephone 100.

The handset 102 preferably comprises a microphone for detecting sound waves produced near the packet-network telephone 100 and for converting the sound waves to electrical signals that, in turn, can be converted to data packets for transmission to a far-end device (e.g., another packet-network telephone). The handset 102 preferably comprises a speaker for converting electrical signals received from a far-end device into sound waves that a single user of the packet-network telephone 100 can detect. Alternatively, instead of using the microphone and speaker of the handset 102, a single user or a plurality of users of the packet-network telephone 100 can use the speaker 112 and the microphone 114 to communicate with one or more far-end devices.

The display 104 can comprise any of a variety of displays available for displaying data. For example, the display 104 can comprise a Liquid Crystal Display (LCD), or an Organic Light Emitting Diode (OLED) display. Other examples of the display 104 for displaying data are also possible.

The display 104 can display various types of data, such as data associated with scheduling a conference call. For example, the display 104 can display a user directory (described below) that identifies potential conference call participants and information associated with each of the potential conference call participants. The number of potential conference call participants displayed on the display 104 depends on various factors, such as size of the display 104, font size used by the display 104, and the number of names in the user directory.

As an example, the display 104 may display five rows of data where in each of the five rows of data list information associated with a respective potential conference call participant from the user directory. If the user directory comprises five or fewer potential conference call participants, then all names associated with the potential conference call participants of the user directory can be displayed on the display 104 at a given time. However, if the user directory comprises six or more names, then the display 104 can display any five of the six or more names of the potential conference call participants of the user directory at any given time. The names of the potential conference call participants of the user directory that are not displayed at any given time can be displayed by pressing one or more of the function selection buttons 106A-106C so as to change which data is displayed on the display 104. Other examples of the number of names of potential conference call participants of a user directory that can be displayed on the display 104 at any given time, and other example of how to display names that are not currently being displayed on the display 104, are also possible.

The function selection buttons 106 (i.e., push-button switches) comprise three functions selection buttons 106A-106C. Alternatively, the function selection buttons 106 may include fewer or more than three function selection buttons. Each function selection button 106A-106C provides means for producing a respective signal associated with each function selection button when that button is pressed.

In one respect, the function selection buttons 106 can be a single-function button that is associated with only a single function, regardless of when the single-function button is pressed. In another respect, one or more of the function selection buttons 106 can be a multi-function button that is associated with (i) a first function (e.g., selecting a name from a user directory) during a first packet-network telephone operating state (e.g., prior to compiling a complete list of potential conference call participants to be selected to participate in a conference call), and (ii) a second function (e.g., sending a request to schedule a conference call) during a second packet-network telephone operating state (e.g., after compiling the complete list of potential conference call participants to be selected to participate in a conference call). In yet another respect, a multi-function button can be associated with three or more functions, where each of the three or more functions can be performed by pressing the multi-function button during a respective operating state of the packet-network telephone 100.

The function selection buttons 106 may be associated with navigating through data that is shown on the display 104 and/or with making a selection based on the data shown on the display 104. For example, the data shown on the display 104 may include a user directory (or a portion of a user directory) that lists potential conference call participants. In this regard, the function selection buttons 106 can be used to scroll through the user directory so as to display potential conference call participants not currently displayed on the display 104, and to select potential conference call participants from the user directory that are shown on the display 104. Other examples of using the function selection buttons 106 with regard to data shown on the display and/or making a selection based on the displayed data are also possible.

The dialing buttons 108 include twelve dialing buttons 108A-108L. Alternatively, the dialing buttons 108 may include fewer or more than twelve dialing buttons. A respective signal is produced when each of the dialing buttons 108A-108L is pressed. The dialing buttons 108 provide means for entering telephone numbers to be called and for entering other information. Each of the dialing buttons 108A-108L is associated with a numeral 0-9 inclusive, a “#” symbol, or a “*” symbol. One or more of the dialing buttons 108 can be associated with one or more letters of an alphabet for use in spelling words. Depending on the operating state of the packet-network telephone 100, pressing a dialing button may represent a numeral, a “#” symbol, a “*” symbol, a letter of an alphabet, or any other symbol or function to be that may be associated with the pressed button.

FIG. 2 depicts additional details of the packet-network telephone 100. In particular, FIG. 2 depicts the packet-network telephone 100 comprising a user interface 114, a packet-network interface 116, a processor 118, and data storage 120, all linked together via a system bus, network, or other connection mechanism 122.

The user interface 114 provides means for a user (or users) to input data into the packet-network telephone 100 and provides means for presenting data to a user (or users) of the packet-network telephone 100. The user interface 114 may comprise the handset 102, the display 104, the function selection buttons 106, the dialing buttons 108, the speaker 110, and the microphone 112, as shown in FIG. 1 and described herein.

The packet-network interface 116 provides interface to a packet-switched network. The packet-network interface 116 may comprise a wired interface that physically couples the packet-network telephone 100 to a packet-switched network. For example, the packet-network interface 116 may comprise a 10 Base-T/100 Base-T2/1000 Base-LX Ethernet interface that physically couples to a packet-switched network. In this regard, for example, the Ethernet interface may be arranged to comply with the Institute of Electrical and Electronics Engineers (IEEE) 802.3® standard for Carrier Sense Multiple Access with Collision Detection (CSMA/CD) Access Method.

Alternatively, or in combination, the packet-network interface 116 may comprise a wireless air interface that interfaces to a packet-switched network via a remote Ethernet interface physically coupled to a packet-switched network, and that is arranged to comply with the IEEE 802.3 standard. As an example, the wireless air interface may comprise an air interface arranged to comply with an IEEE 802.11 standard. Other examples of the packet-network interface 116 are also possible.

The processor 118 may comprise one or more processors (e.g., a general purpose processor and/or a digital signal processor). The processor 118 provides means for executing program instructions so that the processor 118 can work in cooperation with the user interface 102, the packet-network interface 116, and the data storage 120, so as to carry out the functions described herein. For example, the processor 118 may execute particular program instructions in response to receiving signals produced when one of the function selection button 106 is pressed and/or when one of the dialing button 108 is pressed.

The data storage 120 may comprise a computer-readable storage medium such as a magnetic disc, an optical disc, organic memory, and/or any other volatile or non-volatile mass storage system readable by the processor 118. Alternatively, the data storage 120 may comprise a combination of computer-readable storage media. For example, the data storage 120 may comprise a first computer-readable storage medium located within the processor 118 and a second computer-readable storage medium that is located remote from the processor 118. Other examples of computer-readable storage medium and other examples of computer-readable storage media combinations are also possible.

The data storage 120 provides means for storing computer-readable data. In one respect, the data storage 120 may store computer-readable data arranged as program instructions that are executable by the processor 118, such as program instructions to carryout the functions described herein. For example, the data storage 120 may store program instructions executable by the processor 118 for processing signaling protocol messages. Processing signaling protocol messages may comprise (i) compiling and then sending signaling protocol messages, and/or (ii) receiving and then interpreting signaling protocol messages. In this regard, if the processor 118 executes program instructions for processing SIP signaling protocol messages, then the packet-network telephone is a SIP-based packet-network telephone. On the other hand, if the processor 118 executes program instructions for processing H.323 signaling protocol messages, then the packet-network telephone is an H.323-based packet-network telephone.

In another respect, the data storage 120 may store computer-readable data arranged as a user directory or a portion of a user directory. A user directory may include a list of potential conference call participants and information associated with each potential conference call participants. A user directory may be limited to a particular group of potential conference call participants. For example, a user directory may be limited to all users of telephones at a given school or at a given company. As another example, a user directory may be limited to users of packet-network telephones coupled to the Internet and who have registered their names and information for inclusion in the user directory.

Examples of information associated with a potential conference call participant include the name and telephone number of the potential conference call participant. Additional details of a user directory and how a packet-network telephone can receive a user directory are discussed in detail in U.S. Patent Application number 10/922,448, entitled Method and Apparatus for Using a Publicly-Defined Network Protocol to Implement a User Directory, which (i) has attorney reference numbers 04-392 and 3979.CS.US.P, and (ii) is hereby incorporated by reference.

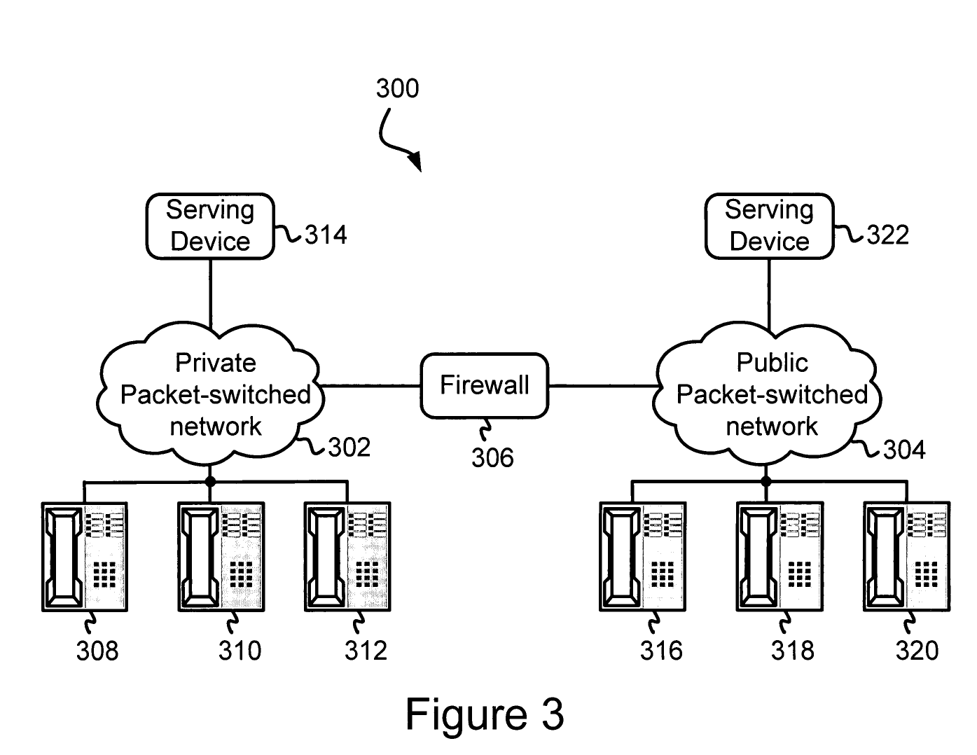

FIG. 3 depicts an example of a system architecture for carrying out the present invention. As shown in the figure, a system 300 comprises a private packet-switched network 302, a public packet-switched network 304, and a firewall 306 that provides network security for the private packet-switched network 302. The private packet-switched network 302 may comprise a Private Branch Exchange (PBX) telephone network. The public packet-switched network 304 may comprise the Internet.

The private packet-switched network 302 has a first packet-network telephone 308, a second packet-network telephone 310, a third packet-network telephone 310, and a first serving device 312, coupled to it. The public packet-switched network 304 has a fourth packet-network telephone 316, a fifth packet-network telephone 318, a sixth packet-network telephone 320, and a second serving device 322, coupled to it. Alternatively, some number of packet-network telephones other than three, and/or some number of serving devices other than one, may be coupled to the private packet-switched network 302 and to the public packet-switched network 304, respectively. Each of the packet-network telephones 308, 310, 312, 316, 318, 320 may be arranged as the packet-network telephone 100 as shown in FIGS. 1 and 2.

The first serving device 314 performs services for client applications loaded onto one or more client devices. Examples of a client device include the first packet-network telephone 308, the second packet-network telephone 310, and the third packet-network telephone 312. The first serving device 314 may perform services for client applications loaded onto client devices coupled to the public packet-switched network 304, as well.

The first serving device 314 may comprise one or more serving devices for performing a respective set of services. For example, the first serving device 314 may comprise a unified messaging serving device for performing unified messaging services. Unified messaging services may include (i) receiving e-mail messages, voice messages, facsimile messages, and other types of messages, and (ii) providing received messages to a user to whom these messages are addressed. Unified messaging services may also include providing message translation such as translating a visual e-mail message to an audible voice message that can be sent to a packet-network telephone associated with the user whom the e-mail message is addressed.

As another example, the first serving device 314 may comprise an e-mail serving device for performing e-mail services for e-mail clients. E-mail services may include receiving e-mail messages, providing notification when an e-mail message has been received, and transmitting received e-mail messages to a device associated with the addressee of the e-mail message. E-mail services may also include maintaining a calendar for a given user of the e-mail serving device. Maintaining a calendar may involve adding a calendar entry for a conference call which the given user has been invited as a participant and/or which the given user has agreed to be a participant.

As yet another example, the first serving device 314 may comprise a conferencing serving device for executing conferencing services. Conferencing services may include services such as (i) scheduling a conference call in response to receiving a request to schedule a conference call, (ii) initiating a conference call at a scheduled conference call start time on a scheduled conference call date, (iii) querying an e-mail serving device calendaring service to determine if potential conference call participants have conflicts with a preferred conference call time on a preferred conference call date and/or to determine if a conflict conference call time and a conflict conference call date allow for more potential conference call participants to participate in the conference call as compared to the preferred conference call time on the preferred conference call date.

Although, the first serving device 314 may comprise a unified messaging service, a conference service and an e-mail service, some client devices may not use one or more of the services that the first serving device 314 can provide. For example, the first packet-network telephone 308 may not include an e-mail client for interfacing with the e-mail service of the first serving device 314. Consequently, the first packet-network telephone does not use an e-mail client to access a user directory of an e-mail service of the first serving device 314. In this regard, the first packet-network telephone 308 uses means other than an e-mail serving device and e-mail service to access a user directory.

The second serving device 322 may be arranged as the first serving device 314. The second serving device 322 may provide services to any of a number of client applications loaded onto one or more client devices. For example, the second serving device 322 may provide services to client applications loaded onto the fourth packet-network telephone 316, the fifth packet-network telephone 318, and the sixth packet-network telephone 320, as well as to client applications loaded to client devices coupled to the private packet-switched network 302.

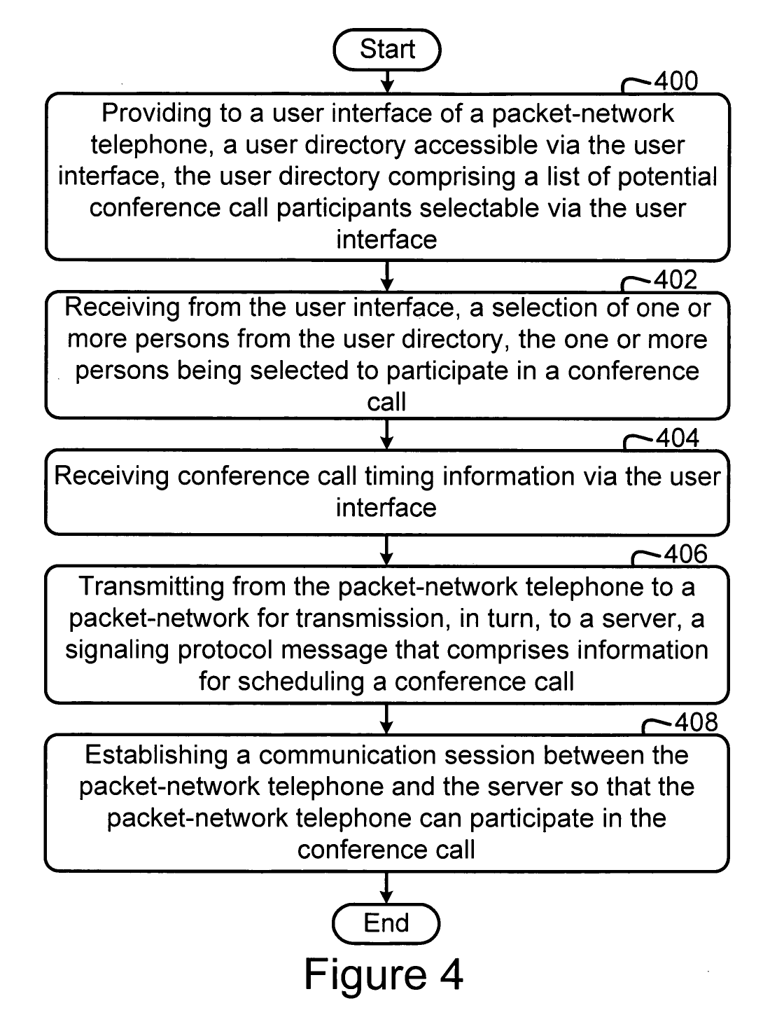

2. Exemplary Operation FIG. 4 is a flow chart provided to illustrate some of the functions that may be carried out with the exemplary embodiment to schedule a conference call using a packet-network telephone. As shown in FIG. 4, block 400 involves providing to a user interface of a packet-network telephone, a user directory accessible via the user interface, wherein the user directory comprises a list of potential conference call participants selectable via the user interface.

A user interface having access to a user directory may be arranged as the user interface 102 of the packet-network telephone 100, both described above with respect to FIG. 2. Various methods may be used to provide the user directory to the packet-network telephone 100, and in turn, to the user interface 102. For example, the packet-network telephone 100 may send a first signaling protocol message (e.g., a SIP message, or an H.323 message) to a serving device (e.g., the first serving device 314) that manages and/or has access to the user directory. The first signaling protocol message may include a request for the serving device to send the user directory (or at least a portion of the user directory) to the packet-network telephone.

As an example, the request for the serving device 314 to send at least a portion of the user directory may comprise a request for the serving device 314 to send the portion of the user directory of the potential conference call participants whose last names start with a given letter of an alphabet (e.g., the letter S). As another example, the request for the serving device to send at least a portion of the user directory may comprise a request for the serving device to send a portion of the user directory that includes potential conference call participants based on a telephone number or telephone extension number. Other examples of the request for the serving device to send at least a portion of the user directory are also possible.

In response to receiving the user directory request sent in the first signaling protocol message, the serving device can send a second signaling protocol message to the packet-network telephone. The second signaling protocol message may include the user directory (or at least a portion of the user directory) to the packet-network telephone. For example, the second signaling protocol message may comprise an entire user directory if the contents of the entire user directory can be embedded in the second signaling protocol message. Alternatively, the second signaling protocol message may comprise only a portion of the user directory in the second signaling protocol message.

The user directory is accessible via the user interface 102. For example, the processor 118 may execute program instructions in response to detecting that one of the function selection buttons 106A-106C was pressed to select presentation of the user directory at the user interface 102. Execution of these program instructions may cause the display 104 to provide a visual representation of the user directory or at least a portion of the user directory.

Next, block 402 involves receiving from the user interface, a selection of one or more persons from the user directory. The one or more persons being selected to participate in a conference call. Various methods may be used to select the one or more persons to participate in the conference call. For example, while the display 104 is displaying the user directory, a user may (i) press the function selection button 106A to select a first person of the user directory whose name is highlighted on the display 104, (ii) press the function selection button 106B to scroll through the user directory until a second person's name is highlighted on the display 104, and (iii) press the function selection button 106A to select the second person of the user directory whose name is highlighted on the display. Alternatively, or in combination with using the function selection buttons to select the one more persons to participate in the conference, the dialing buttons 108 or some other means may be used to select the one or more persons.

The processor 118 receives signals when any of the function selection buttons 106 and/or when any of the dialing buttons 108 are pressed. The processor 118 can determine the selected potential conference call participants from the received signals, based on the names of the potential conference call participants being displayed when one of the function selection buttons 106 or the one of the dialing buttons 108 is pressed to selected a potential conference call participant.

Upon determining each of the one or more persons selected to participate in the conference call, a respective identifier for each person may be added to a request being compiled to schedule a conference call. As an example, a respective identifier for each of the one or more persons may comprise (i) a telephone number, (ii) the person's name, or (iii) a reference number that indicates a position of that person's name relative to the user directory. In this regard, if the selected person's name is the 125^{th} name from the beginning of the user directory when listed in alphabetical order, then a respective identifier for the selected person is “125” . Other examples of a respective identifier for each of the one or more persons selected to participate in the conference call are also possible.

Next, block 404 involves receiving conference call timing information via the user interface. Conference call timing information may be used by a serving device that schedules conference calls, for various reasons. For example, a serving device may use conference call timing information to schedule the conference call and/or to determine if sufficient resources exist at the serving device to carry out the conference call for the number of potential conference call participants selected to participate in the conference.

As another example, a serving device may use conference call timing information to compile invitations that are sent to each of the potential conference call participants selected to participate in the conference call. In this regard, the invitation may comprise an e-mail message, an instant message, a voice message, or some other type of message providing notice to the potential conference call participant of the time, date, and duration of the conference call. The type of invitation (e.g., a voice mail or an instant message) may depend on the type of device that is expected to receive the invitation.

Various conference call timing information may be entered via the user interface. Preferably, conference call timing information comprises a preferred conference call start time (i.e., a time when the conference call is initiated), and a preferred conference date (i.e., a date when the conference call is held).

The conference call timing information may comprise one or more conflict conference call start times, each of which is associated with a conflict conference date. In this way, if some number of potential conference call participants selected to participate in the conference call have an engagement previously scheduled during the preferred conference start time and on the preferred conference date, then the conference call can be scheduled to start at one of conflict conference start times and its associated conflict conference date.

The conference call timing information may comprise data for use in determining a conference call end time. Various data may be used for determining a conference call end time. For example, the data for use in determining a conference call end time may comprise a given time that is later than a conference call start time. For example, if the conference call start time is 3:00 Greenwich Mean Time (GMT), then the data for use in determining the conference call end time could be 5:00 GMT. As another example, the data for use in determining the conference call end time could be a time duration, such as 1.5 hours, such that if the conference call start time is 3:00 GMT, then conference call end time can be determined to be 4:30 GMT.

Receiving the conference call timing information occurs in response using the user interface 102 of the packet-network telephone to enter the conference call timing information. For example, the conference call timing information may be received in response to a user pressing the function selection buttons 106 and/or the dialing buttons 108, in a certain sequence when the display 104 is displaying a prompt for the user to enter the conference call timing information. Other examples of receiving the conference call timing information are also possible.

Next, block 406 involves transmitting a signaling protocol message from the packet-network telephone 100 to a packet-network, wherein the signaling protocol message is destined for a serving device, and wherein the signaling protocol message comprises information for scheduling a conference call.

The signaling protocol message comprising information for scheduling a conference call may be arranged in various configurations. As an example, the signaling protocol message comprising information for scheduling a conference call may comprise an H.323 protocol message.

As another example, the signaling protocol message comprising information for scheduling a conference call may comprise a SIP message, such as a SIP OPTIONS message or a SIP NOTIFY message. In particular, the signaling protocol message comprising the information for scheduling a conference call may be arranged within an SIP event package. Details of event packages are explained in RFC 3265—Session Initiation Protocol (SIP)—Specific Event Notification, June 2002, which is incorporated herein by reference.

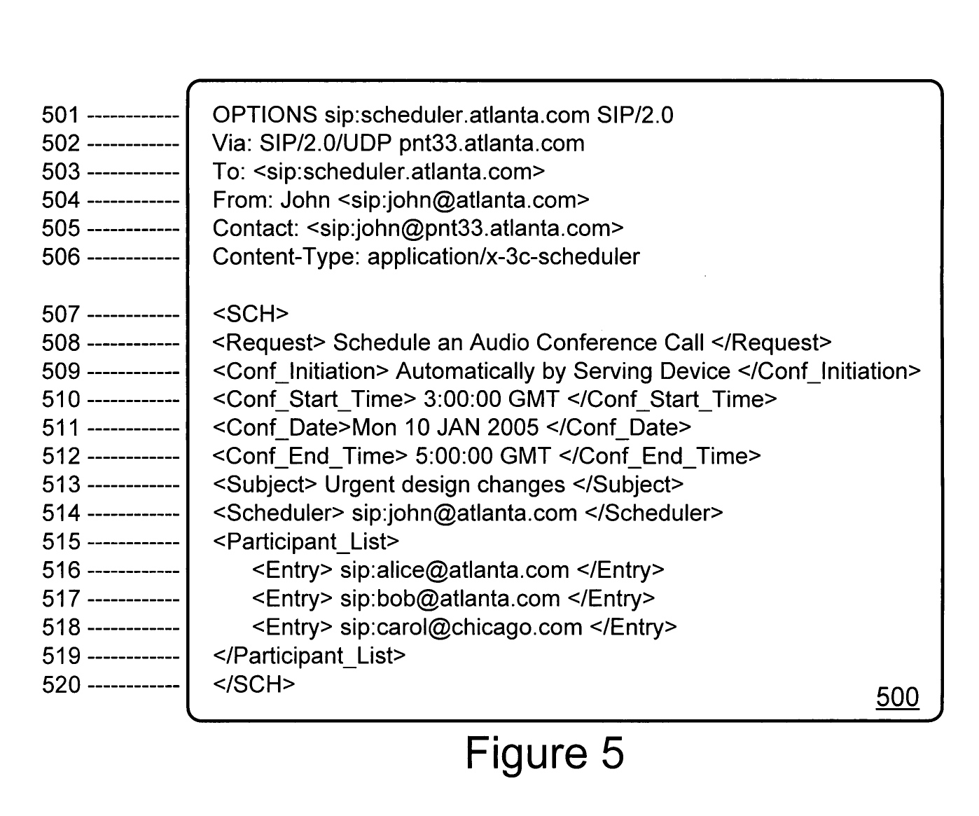

FIG. 5 is a diagram of a signaling protocol message 500 that comprises information for scheduling a conference call. In particular, as an example, the signaling protocol message 500 comprises a SIP OPTIONS message. The signaling protocol message 500 can be sent from the packet-network telephone 100 to a serving device to schedule a conference call. Examples of information that can be included in the signaling protocol message 500 are described below.

The signaling protocol message 500 includes a first line 501, SIP headers 502-506, and a message body 507-520. The message body 507-520 may be arranged according to an Extensible Markup Language (XML) or according to another programming language. The signaling protocol message 500 may include other SIP headers, as well as other information in one or more of the SIP headers shown. The other SIP headers and the other information are not shown in FIG. 5 for clarity of defining the example embodiment.

The first line 501 identifies that the signaling protocol message 500 is a (SIP) OPTIONS message, intended for the URI “sip:scheduler.atlanta.com,” and that the version of SIP being used is “2.0.” URI stands for “Uniform Resource Identifier,” which is a mechanism by which entities on the Internet are identified and located. A URI defined for a user has two parts, a user and a domain, expressed as user@domain. A URI defined for a serving device only includes a domain (e.g., scheduler.atlanta.com).

The “VIA” header 502 specifies the version of SIP (2.0), the transport protocol (UDP), and the hostname of the originator of the signaling protocol message 500 (pnt.33.atlanta.com. The transport protocol may be UDP (User Data Protocol), TCP (Transmission Control Protocol), or some other transport protocol. A transport protocol refers to a protocol used at the transport layer of the Open Systems Interconnection (OSI) reference model, well known to those skilled in the art.

The “To” header 503 identifies the destination URI for the signaling protocol message 500, which matches the URI identified in the first line 501. The “From” header 504 identifies the scheduler of the conference call of the signaling protocol message (John<sip:john@atlanta.com>).

The “Contact” header 505 identifies a return address, such as (sip:john@pnt33.atlanta.com). The return address provides a recipient of the signaling protocol message 500 with sufficient information so that the recipient can reply to the device that sent the signaling protocol message 500. The “Content-Type” header 506 identifies the type of content contained in the message body of the signaling protocol message 500. In this example, the content type is “application/x-3c-scheduler.” In this regard, for example, the content is for an application listed as x-3c-scheduler that can be a serving device conferencing service application. Other examples of the Content-Type are also possible.

With regard to the message body 507-520 of the signaling protocol message 500, line 507 comprises a starting tag “<SCH>” for a conference call scheduling request, and line 520 comprises an ending tag “</SCH>”for the conference call scheduling request.

Line 508 identifies a request and uses a “<Request>” start tag and a “</Request>” end tag as boundaries for identifying the request. In this example, the request is to “Schedule an Audio Conference Call.” Another example of a request is “Schedule a Video Conference.” Other examples of a request contained in the message body of a signaling protocol message are also possible.

Line 509 identifies how the conference call is to be initiated and uses a “<Conf_Initiation>start tag and a “</Conf_Initiation>end tag as boundaries for identifying how the conference call is to be initiated. In this example, the conference call is to be initiated “Automatically by Serving Device.” Other examples of identifying how the conference call is to be initiated include (i) “Automatically by Packet-Network Telephone,” (ii) “Manually by Packet-Network Telephone,” and (iii) “Automatically when all Conference Call Participants are Present.” Other examples of identifying how the conference call is to be initiated are also possible.

Line 510 identifies a conference call start time and uses a “<Conf_Start_Time>start tag and a “</Conf_Start_Time>end tag as boundaries for identifying the conference call start time. In this example, the conference call start time is “3:00:00 GMT.” Other examples of identifying a conference call start time are also possible.

Line 511 identifies a date on which the conference call is to be held and uses a “<Conf_Date>” start tag and a “</Conf_Date>” end tag as boundaries for identifying the date on which the conference call is to be held. In this example, the conference call is to be held on Jan. 10, 2005. If the conference call is to begin on a first date and end on a second date, line 511 may include a “start date” and an “end date.” Other examples of identifying a date (or dates) on which the conference call is to be held are also possible.

Line 512 identifies a conference call end time and uses a “<Conf_End_Time>start tag and a “</Conf_End_Time>end tag as boundaries for identifying the conference call end time. In this example, the conference call end time is “5:00:00 GMT.” Other examples of identifying a conference call end time are also possible.

Line 513 identifies a subject (e.g., a topic to be discussed) of the conference call and uses a “<Subject>” start tag and a “</Subject>” end tag as boundaries for identifying the subject of the conference call. In this example, the subject of the conference call is “Urgent Design Changes.” Other examples of identifying a subject of the conference call are also possible.

Line 514 identifies a conference call scheduler who requests the conference call to be scheduled and uses a “<Scheduler>” start tag and a “</Scheduler>” end tag as boundaries for identifying the conference call scheduler who request the conference call to be scheduled. In this example, the originator is John and is identified by a URI “john@atlanta.com.” Other examples of identifying the conference call scheduler who requests the conference call to be scheduled are also possible.

Line 515 comprises a starting tag “<Participant_List>” for identifying a starting-point of a list of potential conference call participants who have been selected for participating in the conference call, and line 519 comprises an ending tag “</Participant_List>” identifying an end-point of the list of potential conference call participants. Other examples of identifying the starting point of a list of potential conference call participants selected to participate in the conference call are also possible.

Lines 516-518 identify the potential conference call participants selected (from a user directory) for participating in the conference call and each line comprises an “<Entry>” start tag and an “</Entry>” end tag as boundaries for identifying each of the potential conference call participants. In this example, line 516 identifies a first potential participant named Alice, who is associated with a respective identifier “sip:alice@atlanta.com,” line 517 identifies a second potential participant named Bob, who is associated with a respective identifier “sip:bob@atlanta.com,” and line 518 identifies a third potential participant named Carol, who is associated with a respective identifier “sip:carol@chicago.com.” Other examples of identifying the potential conference call participants selected to participate in the conference call are also possible.

Returning back to FIG. 4, next, block 408 involves establishing a communication session between the packet-network telephone 100 and the serving device so that the packet-network telephone 100 can participate in the conference call with other calling devices that establish communication sessions with the serving device. Various methods can be used to establish the communication session between the packet-network telephone 100 and the serving device.

For example, establishing the communication session can involve auto-initiation of the communication session by the serving device, where the serving device originates establishing the communication session with the packet-network telephone 100. Auto initiation of the communication session by the serving device involves the serving device sending a signaling protocol message to the packet-network telephone 100 upon the serving device detecting occurrence of the conference start time on the conference date. Preferably, the signaling message for auto-initiation of the communication session comprises a SIP INVITE message, although another SIP message (e.g., a SIP OPTIONS message) or a message from another signaling protocol (e.g., H.323 protocol) could also be used.

One or more other signaling protocol messages (one of which can be a SIP ACK message) may be sent between the packet-network telephone 100 and the serving device to completely establish the communication session between the packet-network telephone 100 and the serving device. After establishing the communication session between the packet-network telephone 100 and the serving device, the serving device can perform a media mixing function by which the packet-network telephone 100 can communicate with calling devices associated with other conference call participants that have established a respective communication session with the serving device.

The other calling devices that establish communication sessions with the serving device may be calling devices associated with the conference call participants selected to participate in the conference call. The serving device may auto-initiate establishing the communication sessions with the other calling devices by sending signaling protocol messages to the other calling devices upon the serving device detecting occurrence of the conference start time on the conference date.

As another example, establishing the communication session between the packet-network telephone 100 and the serving device can involve auto-initiation of the communication session by the packet-network telephone 100. Auto-initiation of the communication session by the packet-network telephone involves the packet-network telephone 100 originating the communication session, which may begin upon the packet-network telephone detecting occurrence of the conference start time on the conference date. The packet-network telephone 100 may send a signaling protocol message (e.g., a SIP INVITE message) to initiate establishing the communication session.

As yet another example, establishing the communication session can involve manual-initiation of the communication session by the packet-network telephone 100, where the packet-network telephone 100 originates establishing the communication session. Manual-initiation of the communication session by the packet-network telephone 100 can involve the packet-network telephone 100 sending a signaling protocol message to the serving device in response to the user of the packet-network telephone 100 using the user interface 102 (e.g., pressing one of the function selection buttons 106) to trigger the sending of the signaling protocol message. Preferably, the user uses the user interface 102 upon the occurrence of the conference start time on the conference date. In this way, a communication session can be set up with the serving device that has reserved serving device resources for the conference call.

3. Conclusion An exemplary embodiment of the present invention have been described above. Those skilled in the art will understand, however, that changes and modifications may be made to the embodiment described without departing from the true scope and spirit of the present invention, which is defined by the claims.

We claim:

1. A method for using a packet-network telephone to schedule a conference call, the method comprising:
providing to a user interface of a packet-network telephone, a user directory accessible via the user interface, wherein the user directory comprises a list of potential conference call participants that are selectable via the user interface;
receiving from the user interface, a selection of one or more persons from the user directory, wherein the one or more persons are selected to participate in a conference call; and
transmitting a first signaling protocol message from the packet-network telephone to a packet-network, wherein the first signaling protocol message is destined for a serving device, and wherein the first signaling protocol message comprises (i) a request to schedule the conference call, and (ii) a respective identifier for each of the one or more persons selected to participate in the conference call.

2. The method of claim 1, wherein the first signaling protocol message comprises a Session Initiation Protocol (SIP) message.

3. The method of claim 2, wherein the SIP message comprises a SIP OPTIONS message.

4. The method of claim 2, wherein the SIP message comprises a SIP NOTIFY message.

5. The method of claim 2, wherein the request to schedule the conference call and the respective identifier for each of the one or more persons selected to participate in the conference call are arranged according to an Extensible Markup Language (XML).

6. The method of claim 1, wherein the first signaling protocol messages comprises an H.323 message.

7. The method of claim 1, wherein the first signaling protocol message further comprises an identifier associated with a user of the packet-network telephone.

8. The method of claim 1, further comprising:
receiving from the user interface, a conference start time and a conference date,
wherein the first signaling protocol message further comprises the conference start time and the conference date.

9. The method of claim 8, further comprising:
establishing a communication session between the packet-network telephone and the serving device so that a user of the packet-network telephone can participate in the conference call,
wherein establishing the communication session comprises receiving from the serving device a second signaling protocol message, and
wherein the serving device transmits the second signaling protocol message upon occurrence of the conference start time on the conference date.

10. The method of claim 9, wherein the second signaling protocol message comprises a SIP INVITE message.

11. The method of claim 9, wherein the conference call is carried out between the packet-network telephone and one or more other packet-network telephones that are associated with the one or more persons selected to participate in the conference call.

12. The method of claim 8, further comprising:
receiving from the user interface, data for use in determining a conference end time,
wherein the data for use in determining the conference end time is data selected from the group consisting of (i) a given time that is later than the conference start time, and (ii) a time duration, and
wherein the first signaling protocol message further comprises the data for use in determining the conference end time.

13. The method of claim 1, wherein the serving device comprises a conference serving device that schedules the conference call upon receiving the first signaling protocol message that comprises the request to schedule the conference call.

14. The method of claim 1, wherein providing to a user interface of a packet-network telephone, a user directory accessible via the user interface, comprises:
sending a second signaling protocol message from the packet-network telephone to the serving device, wherein the second signaling protocol message comprises a request for the serving device to send at least a portion of the user directory to the packet-network telephone; and
receiving at the packet-network telephone, a third signaling protocol message that comprises the at least a portion of the user directory.

15. A method for using a packet-network telephone to schedule a conference call, the method comprising:
providing to a user interface of a Signaling Interface Protocol (SIP)-based packet-network telephone, a user directory accessible via the user interface, wherein the user directory comprises a list of potential conference call participants that are selectable via the user interface, and wherein the user directory is provided to the SIP-based packet-network telephone via at least a first SIP message;
receiving from the user interface of the SIP-based packet-network telephone, a selection of one or more persons from the user directory, wherein the one or more persons are selected to participate in a conference call; and
transmitting a second SIP message from the SIP-based packet-network telephone to a packet-network, wherein the second SIP message is destined for a SIP-based serving device, and wherein the second SIP message comprises (i) a request to schedule the conference call, and (ii) a respective identifier for each of the one or more persons selected to participate in the conference call.

16. The method of claim 15, wherein the first SIP message comprises a SIP message selected from the group consisting of (i) a first SIP NOTIFY message, and (ii) a first SIP OPTIONS message, and wherein the second SIP message comprises a SIP message selected from the group consisting of (i) a second SIP NOTIFY message, and (ii) a second SIP OPTIONS message.

17. The method of claim 16, further comprising:
entering a conference start time, a conference date, and data for use in determining a conference end time, via the user interface of the SIP-based packet-network telephone;
wherein the second SIP message further comprises the conference start time, the conference date, and the data for use in determining the conference end time.

18. A packet-network telephone for scheduling a conference call, the packet-network telephone comprising:
a user interface;
a processor; and
data storage comprising instructions executable by the processor for causing the packet-network telephone to:
provide to the user interface, a user directory accessible via the user interface, wherein the user directory comprises a list of potential conference call participants that are selectable via the user interface;
receive from the user interface, a selection of one or more persons from the user directory, wherein the one or more persons are selected to participate in a conference call; and
transmit a first signaling protocol message to a packet-network, wherein the first signaling protocol message is destined for a serving device, and wherein the first signaling protocol message comprises (i) a request to schedule the conference call, and (ii) a respective identifier for each of the one or more persons selected to participate in the conference call.

19. The packet-network telephone of claim 18, wherein the user interface comprises means for entering a conference start time and a conference date, and wherein the first signaling protocol message further comprises the conference start time and the conference date.

20. The packet-network telephone of claim 19, further comprising a packet-network interface,
wherein the data storage further comprises instructions executable by the processor for causing the packet-network telephone to process a second signaling protocol message received at the network interface, wherein the second signaling protocol message initiates setting up a communication session between the packet-network telephone and the serving device for use during the conference call.

21. The packet-network telephone of claim 15, wherein the user interface comprises a display to provide the user directory at the user interface.
